(19) United States
(12) Patent Application Publication
(10) Pub. No.: US 2014/0195351 A1
(43) Pub. Date: Jul. 10, 2014

(54) KIOSK NETWORK SYSTEM

(71) Applicants: Warren Frank Lasch, Johns Island, SC (US); Caleb Isaac Yaryan, Goose Creek, SC (US); Charles Darby Priest, Summerville, SC (US)

(72) Inventors: Warren Frank Lasch, Johns Island, SC (US); Caleb Isaac Yaryan, Goose Creek, SC (US); Charles Darby Priest, Summerville, SC (US)

(73) Assignee: CITY CORIDOR, LLC, North Charleston, SC (US)

(21) Appl. No.: 14/237,869

(22) PCT Filed: Aug. 8, 2012
(86) PCT No.: PCT/US2012/049996

§ 371 Date: Feb. 8, 2014

Related U.S. Application Data
(60) Provisional application No. 61/521,519, filed on Aug. 9, 2011.

(51) Int. Cl. G06Q 30/02

(52) U.S. Cl. CPC G06Q 30/0261
USPC 705/14.58

(57) ABSTRACT

A platform is provided having a network of interactive kiosks with multiple local services running on each individual kiosk. The kiosk network provides users or interested viewers with relevant information, as well as the ability to react to such information in a relevant manner.

### CROSS-REFERENCE TO RELATED APPLICATIONS

The present invention claims priority to pending U.S. Provisional Application No. 61/521,519 filed Aug. 9, 2011 which is incorporated herein by reference.

### BACKGROUND

The present invention relates generally to kiosks, and, in particular, to devices, methods and systems for providing relevant information about goods and services through stand-alone structures operated through networks. More specifically, the present invention is related to kiosk networks wherein the kiosk is interactive with a network for ticket distribution optimization and control and wherein the display is demographically and biometrically optimized to the user.

Retailers and service providers alike continue to seek means for providing more relevant information through more easily accessible platforms to their respective consumer base. Kiosks can provide a publicly-accessible platform for accessing images relating to goods and services, as well as other relevant information that inspire purchases, or simply, garner attention.

Such kiosks have application in a wide variety of industries, as well as within government entities. Not only can retail purchases be made through a kiosk, but airline tickets can be purchased and redeemed, drivers' licenses can be renewed, taxes can be paid, and so on.

Though kiosks are widely used they are still limited by the fact that they are primarily response oriented without the ability to tailor advertisement and offers of service based on biometric and demographic information.

### SUMMARY

The following presents a simplified summary of the invention in order to provide a basic understanding of some aspects of the invention. This summary is not an extensive overview of the invention. It is not intended to identify key or critical elements of the invention or to delineate the scope of the invention; its sole purpose is to present concepts of the invention in a simplified form as a prelude to the more detailed description that is subsequently presented.

It is an object of the invention to provide an apparatus and method for providing relevant information, such as advertisements and tickets, through the use of a distributed interactive kiosk network that is managed from a cloud platform.

It is another object of the invention to provide a kiosk which is responsive to biometric and demographic information.

These and other embodiments, as will be realized, are provided in a kiosk network. The kiosk network has at least one kiosk. The kiosk has a display capable of providing displayed information to a user; a user interface capable of receiving user input; a payment processor capable of receiving payment input; a printer capable of printing a ticket comprising a specific indicator; an optical sensor capable of capturing demographic and biometric information of a user and a communication link capable of transmitting the user input, the payment input and the demographic and biometric information and receiving the specific indicator and the displayed information. A cloud service is provided which is capable of receiving the user input, the payment input and the demographic and biometric information from the kiosk and transmitting the specific indicator and the displayed information to the kiosk. A merchant inventory system is provided. The merchant inventory system has a merchant processor capable of receiving the payment input from the cloud service to confirm payment and transmitting confirmation to the cloud service. The merchant inventory system also has a merchant ticket verification system capable of receiving the confirmation from the cloud service, generating the specific indicator, and transmitting the specific indicator to the cloud service. The merchant inventory system also has a merchant ticket module capable of reading the ticket and confirming the specific indicator and transmitting ticket confirmation to the cloud service. A merchant inventory is provided which is capable of receiving the ticket confirmation from the cloud service and updating inventory of items in inventory with the confirmed specific indicator. A demographic analyzer is provided which is capable of receiving the demographic and biometric information from the cloud service and transmitting a demographic profile to the cloud service. A kiosk management system is provided which is capable of receiving the demographic profile from the cloud service and providing the displayed information to the cloud service wherein the displayed information is related to the demographic profile.

### BRIEF DESCRIPTION OF FIGURES

FIG. 1 is a flowchart representation of an embodiment of the invention.

FIG. 2 is a schematic representation of a kiosk of the instant invention.

### DESCRIPTION

The present invention is related to a kiosk network wherein a user can access services and products at the kiosk. More specifically, the kiosk is interactive with cloud services wherein products or services offered can be manipulated based on demographic and biometric information obtained at the kiosk.

The present invention includes a method for providing relevant information, such as advertisements and tickets, through the use of a distributed interactive kiosk network that is managed from a cloud platform. The present invention contemplates that such a kiosk network has application in a wide variety of industries, as well as with government entities.

One embodiment of the present invention includes a platform having a network of interactive kiosks with multiple local services running on each individual kiosk. These local services include dynamic data-driven advertising, ticket sales, payment processing, demographics gathering, biometric information gathering, external data services input, and printing. The services all run locally and have a two way encrypted connection via a service bus or HyperText Transfer Protocol Secure (HTTPS) connection to a cloud based back end. The cloud back end runs multiple services that can push and pull data to and from each kiosk location. These non-local or remote services include: external data gathering, demographic and biometric data analysis, ticket inventory validation, ticket redemption service, kiosk performance metrics, and a vendor portal for updating inventory, changing ticket prices, redeeming tickets, and changing ad content. In addition to the cloud back end and the kiosk network is a merchant ticket redemption platform that allows merchants to scan tickets sold through the kiosk via a mobile device and have these tickets redeemed through the cloud back end ticket redemption service.

The invention will be described with reference to the figures which are an integral, non-limiting, component of the disclosure. Throughout the description similar elements will be numbered accordingly.

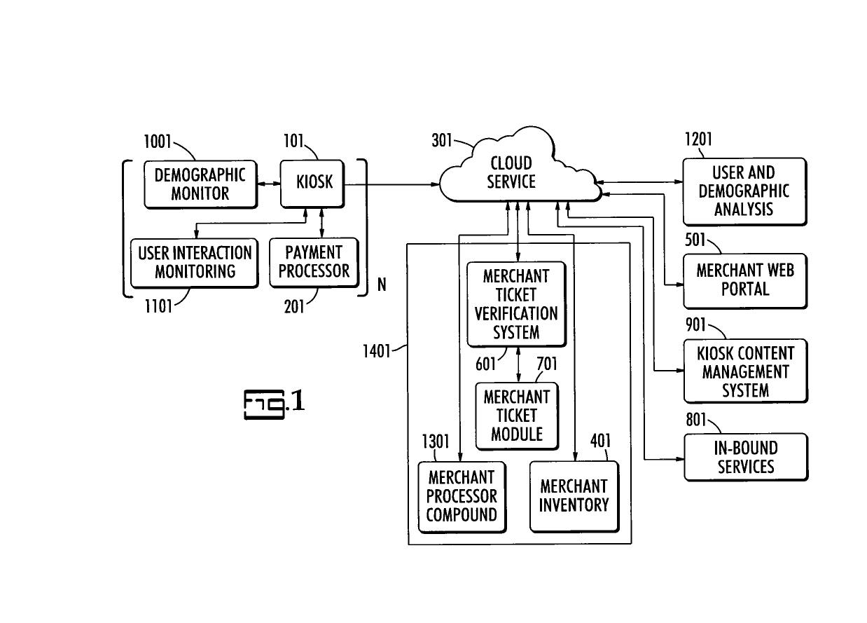

An embodiment of the invention is illustrated in flowchart form in FIG. 1. In FIG. 1, a kiosk 101 is illustrated. As would be realized any number (n) of kiosks can be employed in the network even though only one is illustrated for convenience.

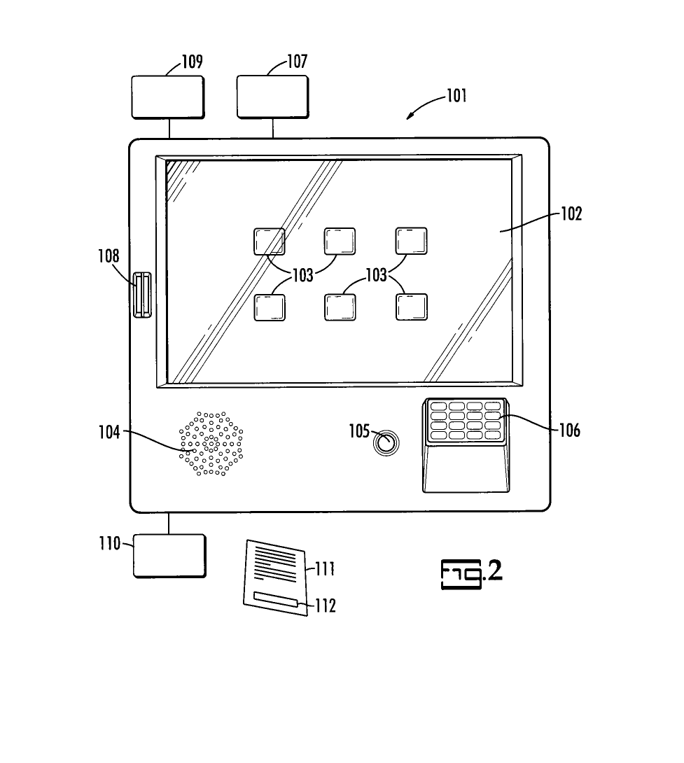

A kiosk will be described with reference to FIG. 2 wherein a kiosk 101 is illustrated schematically. The kiosk comprises a display screen 102 capable of displaying information in the form of visible images 103 such as icons and preferably interactive icons. It is preferable that the display screen be a touch screen display as widely known in the art. Further, the touch screen interface is comprised of interactive ad content. Although a number of designs and materials for the kiosk can be employed and are contemplated by the present invention, the kiosk screen can include glasses-free 3D capabilities, as well as holographic displays. A user interface provides the ability to purchase event tickets, make dinner reservations, hotel reservations, get directions and print maps, check flight status, and get additional information related to local businesses, attractions, and events. As previously discussed, the kiosk structure, which may be a cabinet design, can include various designs, materials and components depending on the preferences and particular application of the particular application of the kiosk. The cabinet design can include design features such as: a mobile unit; an outdoor unit; durability features; ease of maintenance features in rear of cabinet; internal electronic equipment mounting apparatus; and a front panel interchangeability system.

A speaker 104 provides audible signals to the user and is preferably a two-way speaker which allows the user to speak commands as a form of user input to the kiosk either in addition to, or in lieu of, touch commands on the screen or auxiliary devices which are the primary user inputs. An optical sensor 105 such as a video or still camera, captures images for biometric and demographic analysis as will be further described herein. An optional but preferred auxiliary input device 106 such as a keypad, touchpad or the like allows for user input to augment or supplement touch commands on the screen. A communication module, 107, allows the kiosk to send and receive information through optical, wired or wireless communication technologies or combinations thereof. A card reader 108 allows payment input for services or purchases as will be more fully described herein. An optional, but preferred, locator 109 such a global positioning satellite locator allows the location of the kiosk to be determined and transmitted from the kiosk. A locator is particularly useful for mobile kiosk whether movement is intended or a result of vandalism. For fixed kiosk the locator may not be necessary. A printer 110 allows material including tickets 111 which may include maps, confirmations, access to events and the like to be printed for use by the user. The ticket has a specific indicator 112 which will be described more fully herein.

With reference back to FIG. 1, a payment processor 201 is connected to or integral to the kiosk 101. The payment processor preferably includes a card reader, 108 of FIG. 2., with associated software resident in either the reader or the kiosk. The card reader is preferably integral to the kiosk. Card data is captured and preferably transmitted via a secured encrypted web based third party data platform. This data is transmitted through the cloud services 301 to the merchant processor component 1301 for approval. If the transaction is approved data is relayed through the cloud services 301 to software residing on the kiosk 101. If approved, a ticket is printed with a specific indicator and the specific indicator is transmitted thought the cloud services 301 to a merchant ticket verification system 601. The ticket sales information is also transmitted to the merchant inventory module 401 for inventory control. When the ticket is redeemed a merchant ticket module 701 reads the specific indicator of the ticket and transmits the specific indicator to the merchant ticket verification system 601 wherein the specific indicator is validated and the inventory of tickets redeemed is updated at the merchant inventory 401. The merchant ticket verification system, merchant processor component, merchant ticket module and merchant inventory may be within a merchant inventory system 1401.

The cloud services 301 is a system and method for aggregating all of the data generated by the kiosk services or other external services and provides a centralized management platform for that data. The cloud services has a persistence encrypted bi-directional Transmission Control Protocol (TCP) connection to each kiosk 101 and external service. This connection allows the kiosk 101 to update the centralized cloud services component 301 in real time and vice versa. The cloud services component 301 acts as the central distribution point for all kiosks 101 in the network thus allowing a single point of management.

An inventory validation system is an additional feature and component of the present invention. In the exemplary embodiment, the inventory system includes a merchant inventory module 401 for inventory availability information for merchants that are selling goods or services, such as entertainment services, on the kiosk 101 system. This feature allows the merchants to insure that they are able to set limits on the number and time of goods and services sold and to validate remaining quantities in real time.

Another component of the present invention is merchant web portal 501. This component is a website to which merchants can log in and receive real time feed back about performance of their ads or goods and services being sold. The merchants can also use the merchant web portal 501, which is connected through cloud services 301 to the merchant inventory module 401, to change inventory numbers, verify ticket validation, set pricing information, and change inventory levels. The merchant web portal 501 can further be used to view other applicable data from the entire kiosk network.

In addition to the previously described merchant components is a merchant ticket verification system 601 connected to a merchant ticket component 701. The merchant ticket verification system 601 is preferably a stand-alone application that can run from a mobile device. The merchant ticket verification system 601 allows a merchant to scan a ticket using the merchant ticket module 701 where the scan reports the specific indicator of the ticket to the merchant ticket verification system 601. This provides confirmation that the ticket is the actual ticket printed by the kiosk and not an invalid ticket. Each ticket printed from the kiosk network has a specific indicator which can be an identification code or marker that is recognized by the merchant ticket verification system 601. The merchant ticket verification system 601 can validate if the ticket has previously been redeemed. Once the ticket is verified and redeemed by the merchant, the ticket will automatically be taken out of available tickets, thus providing the merchant with a means to view and identify outstanding tickets. Furthermore, the merchant inventory 401 can be updated to reflect the status or availability of tickets through cloud services 301.

The present system also includes an in-bound data services component 801. The in-bound data services component is a method for retrieving external data from unrelated databases, aggregating that data into a single database and sending required data values to each kiosk 101 in the network when any required value changes. This component also allows each kiosk 101 to query its own data values. Representative incoming data may include such information as time, weather, vehicle traffic, foot traffic, mass transit loading and unloading and the like each of which could alter the available or suitable services or events. For example, a large influx of incoming passengers near a meal time may make meal related request more relevant whereas at other times information on entertainment venues may be of interest to a larger percentage of users.

A kiosk content management system 901 is provided to allow merchants that are represented on the kiosk network to log in and update their content. These changes can be set to alter values or entire ads based on a wide variety of dynamic variables. The changes are sent through an approval process and then promoted to the entire network or to an individual kiosk.

A demographic monitoring component 1001 gathers user information such as visual indications and appearance through the use of optical scanner, such as a camera, built into the kiosk in conjunction with technology, such as the commercially available Intel AIM software platform, data points are gathered to indicate likely gender, age range, number of potential viewers, number of actual viewers, duration of interaction and type of interaction. This type of data can then be used to generate a demographic profile by the demographic analysis component.

A user interaction monitoring component 1101 can be provided that includes a touch screen interface in conjunction with the software platform. All interactions with individual components of the interface are monitored and utilized by the demographic analysis component for input to the demographic profile. The user interaction monitoring component can also determine information such as the number of people in a group, information about the group for input into the demographic profile. By way of example, if the group has five members a component of the demographic profile could be used to insure that a particular event having only four available tickets does not appear for consideration. The user interaction monitoring component can also monitor the touch screen to analyze patterns in use. For example, if certain regions of the touch screen are touched preferentially the icons can be moved to either alter the selection rate of certain activities or confirm the preference of screen location. Also, if certain activities are typically coupled, such as a specific show and a site-seeing expedition, the vendor can alter the display to encourage coupling of these activities. Alternatively, if activities are not coupled and the vendors would prefer them to be coupled incentives, by visual positioning or discounts, could be included.

Another component of the present invention includes a user demographic analysis component 1201. Each kiosk on the network gathers demographic information via an onboard optical scanner as a demographic monitoring component or the user interface monitoring component. This data is then sent to the cloud services to aggregate the information from the entire network and then provide merchants with feedback based on the performance of their ad or sales in comparison to other merchants, locations, or ad campaigns. The merchants will further be able to learn number of views, number of potential views, age and gender of the viewers across the entire network per location. Merchants can therefore factor this type of information in the selection and display of more relevant or user-interesting information through the kiosk network.

By correlating purchased tickets to demographic or biometric information the rotation or positioning of information on a kiosk can be optimize to the surrounding audience. By way of non-limiting example, if a group with a definable demographic or biometric match demonstrates a preference to a certain form of entertainment this information can be captured. When a new user approaches the kiosk they can be quickly analyzed based on biometric and demographic parameters and if they match a defined group the kiosk display can be updated such that forms of entertainment may be displayed preferentially, more prominently or earlier in a rotating queue consistent with the group. This maximizes the effectiveness of the kiosk experience for the user.

The kiosk network of the present invention can have a wide variety of applications, including but not limited to the hospitality industry, as well as government-related industry.

The communication linkages described herein are not particularly limited and any form of communication employed for communication between computers is suitable for demonstration of the invention.

Those skilled in the kiosk and network arts will appreciate from the foregoing description of embodiments that substitutions and modifications can be made without departing from the spirit and scope of the invention which is defined by the appended claims.

What is claimed is:

1. A kiosk network comprising:
at least one kiosk wherein said kiosk comprises:
a display capable of providing displayed information to a user,
a user interface capable of receiving user input;
a payment processor capable of receiving payment input;
a printer capable of printing a ticket comprising a specific indicator;
an optical sensor capable of capturing demographic and biometric information of a user; and
a communication link capable of transmitting said user input, said payment input and said demographic and biometric information and receiving said specific indicator and said displayed information;
a cloud service capable of receiving said user input, said payment input and said demographic and biometric information from said kiosk and transmitting said specific indicator and said displayed information to said kiosk;
a merchant inventory system comprising:
a merchant processor capable of receiving said payment input from said cloud service to confirm payment and transmitting confirmation to said cloud service;
a merchant ticket verification system capable of receiving said confirmation from said cloud service, generating said specific indicator, and transmitting said specific indicator to said cloud service;
a merchant ticket module capable of reading said ticket and confirming said specific indicator and transmitting ticket confirmation to said cloud service;
a merchant inventory capable of receiving said ticket confirmation from said cloud service and updating inventory of items in inventory with said confirmed specific indicator;
a demographic analyzer capable of receiving said demographic and biometric information from said cloud service and transmitting a demographic profile to said cloud service; and
a kiosk management system capable of receiving said demographic profile from said cloud service and providing said displayed information to said cloud service wherein said displayed information is related to said demographic profile.

2. The kiosk network of claim 1 wherein said display comprises a touch screen.

3. The kiosk network of claim 1 wherein said displayed information is an icon.

4. The kiosk network of claim 3 wherein said icon is an interactive icon.

5. The kiosk network of claim 1 wherein said kiosk further comprises a speaker.

6. The kiosk network of claim 1 wherein said payment processor comprises a card reader.

7. The kiosk network of claim 1 wherein said optical sensor is selected from a still camera and a video camera.

8. The kiosk network of claim 1 wherein said kiosk further comprises a position locator.

9. The kiosk network of claim 1 further comprising a merchant web portal in communication with said cloud service.

10. The kiosk network of claim 9 wherein said merchant web portal is in communication with said merchant inventory module through said cloud service.

11. The kiosk network of claim 10 wherein said merchant web portal communicates at least one of changes in inventory numbers, price changes and changes in inventory levels.

12. The kiosk network of claim 1 further comprising an inbound data service module in communication with said cloud service.

13. The kiosk network of claim 1 further comprising a kiosk content management system.

14. The kiosk network of claim 12 wherein said kiosk content management system provides changes in said displayed information on said kiosk.

15. The kiosk network of claim 1 wherein said kiosk is mobile.

16. The kiosk network of claim 1 wherein said merchant ticket module is a stand alone component.
